(19) United States
(12) Patent Application Publication
(10) Pub. No.: US 2010/0011980 A1
(43) Pub. Date: Jan. 21, 2010

(54) METHOD AND MACHINE FOR TREATING A REUSABLE PRINTING TECHNOLOGY SURFACE WITH AT LEAST ONE LIQUID AND MACHINE FOR PROCESSING PRINTING MATERIAL

(75) Inventors: Helge Grandt, Sandhausen (DE); Bernd Hoffmann, Schifferstadt (DE); Alexander Matern, Oftersheim (DE); Michael Pasuch, Walldorf (DE)

Correspondence Address: LERNER GREENBERG STEMER LLP, P O BOX 2480, HOLLYWOOD, FL, 33022-2480, US

(73) Assignee: HEIDELBERGER DRUCKMASCHINEN AG, Heidelberg (DE)

(21) Appl. No.: 12/503,411

(22) Filed: Jul. 15, 2009

(30) Foreign Application Priority Data
Jul. 16, 2008 (DE) 10 2008 033 502.9

(51) Int. Cl. B41F 35/00

(52) U.S. Cl. 101/425

(57) ABSTRACT

A method for treating a reusable printing technology surface, preferably a printing form that can be re-imaged, with at least one liquid, for example cleaning fluid, rinsing liquid, solution of amphiphilic molecules or gumming agent, includes rotating the printing technology surface about a cylinder axis, applying the liquid to the printing technology surface in the form of a jet and at a varying angle and contacting the printing technology surface with a movable cloth. The printing technology surface is rotated at a varying rotational speed. The rotational speed is preferably varied in stages, in particular increased, in order to achieve the best possible treatment results, for example cleaning and (re-) covering with amphiphilic molecules. The method can preferably be implemented in a printing press or a plate exposer. A machine for treating a reusable printing technology surface and a machine for processing printing material, are also provided.

### CROSS-REFERENCE TO RELATED APPLICATION

This application claims the priority, under 35 U.S.C. §119, of German application DE 10 2008 033 502.9, filed Jul. 16, 2008; the prior application is herewith incorporated by reference in its entirety.

### BACKGROUND OF THE INVENTION

### Field of the Invention

The present invention relates to a method for treating a reusable printing technology surface with at least one liquid, which includes rotating the printing technology surface about a cylinder axis, applying liquid to the printing technology surface in the form of a jet and at a varying angle, and contacting the printing technology surface with a movable cloth. The invention also relates to a machine for processing printing material, for example a printing press, in particular a sheet-processing rotary printing press for lithographic offset printing. The invention further relates to a machine for treating printing technology surfaces, for example a printing press, in particular a sheet-processing rotary printing press for lithographic offset printing or, for example, a printing plate processor, in particular a printing plate exposer.

In the area of the so-called graphic industry, printing materials, for example paper, board or film, are provided with printed images, in particular printed. The application of the printed images can be carried out through the use of rotary printing presses, which have printing form cylinders for that purpose. The printing form cylinders in turn normally carry printing forms, for example flexible printing plates, provided with the printing image, which means that they are imaged and inked. The printing forms can be imaged either once or many times and can thus be reusable.

The imaging of the printing forms can be carried out through the use of lasers, which transfer the image information onto a surface layer of the printing form that can be imaged. In the case of printing forms that can be re-imaged, that layer has to be refreshed, in particular erased, after each print job and before renewed imaging.

German Published, Non-Prosecuted Patent Application DE 102 27 054 A1, corresponding to U.S. Pat. No. 6,851,366, discloses a reusable printing form having a naturally oxidized, hydrophilic titanium printing surface which is covered on a nanoscopic scale, for example with phosphonic acid or hydroxamic acid. An image can be written onto that hydrophobic covering through the use of laser radiation, with the covering being removed at the irradiated points. In that way, the printing surface is structured into hydrophilic and hydrophobic regions.

After printing with such a printing form, the latter is cleaned of printing ink and covering and provided with a new covering. German Published, Non-Prosecuted Patent Application DE 10 2007 057 798 A1 discloses a method with which a covered printing technology surface is cleaned and covered through the use of a cloth treatment device. German Published, Non-Prosecuted Patent Application DE 10 2007 038 141.9, corresponding to copending U.S. application Ser. No. 12/176,737, filed Jul. 21, 2008, discloses an apparatus for treating a printing technology surface with process liquids, which includes a number of pivotable groups of jet nozzles and a cloth device. The rotational speed of the printing technology surface is constant in that case, as is the feed speed or feed cycle rate of the cloth and the metered quantity of liquid.

### SUMMARY OF THE INVENTION

It is accordingly an object of the invention to provide a method and a machine for treating a reusable printing technology surface with at least one liquid and a machine for processing printing material, which overcome the hereinafore-mentioned disadvantages of the heretofore-known methods and machines of this general type and which permit the optimized processing, which is to say treatment with at least one liquid, preferably a plurality of liquids, of a printing technology surface, in particular of a printing form. In this case, optimization means increasing the process quality, minimizing the consumable materials (liquids, cloth), minimizing the process time (overall process, individual process steps), shortening the so-called changeover times, reducing costs (operating costs, disposal costs) and/or reducing pollution.

With the foregoing and other objects in view there is provided, in accordance with the invention, a method for treating a reusable printing technology surface with at least one liquid. The method comprises rotating the printing technology surface at a varying rotational speed about a cylinder axis, applying the liquid to the printing technology surface in the form of a jet and at a varying angle, and contacting the printing technology surface with a movable cloth.

As a result of the variable rotational speed, preferably matched to the current process step, the implementation of the method according to the invention permits, amongst other things, the advantageous optimization of the treatment of the printing technology surface, for example with regard to increasing the process quality, minimizing the consumable materials (liquids, cloth), minimizing the process time (overall process, individual process steps), shortening the so-called changeover times, reducing costs (operating costs, disposal costs) and/or reducing pollution. The variable rotational speed can, for example, be matched to the application of liquid, so that it is possible to operate at low rotational speed during the application and at high rotational speed after the application. The variable rotational speed can also, for example, be matched to the angular position of the printing technology surface or the number of rotations carried out, so that, for example, rotation is slow in the leading edge region and fast in the region between the leading edge region and the trailing edge region or rotation is faster as the number of rotations increases (for example during cleaning). The variation can be carried out by controlling on the basis of known and stored data from the instantaneous process step and/or the preceding process steps.

In accordance with another mode of the method of the invention, which is advantageous and therefore preferred due to the achievable minimization of the cloth consumption, the cloth is moved at a varying feed speed, preferably matched to the current process step. Furthermore, in this way, an increase in the process quality can be achieved in an advantageous way, since the variable feed speed permits the provision of cloth of desired length and absorption capacity (clean cloth or already used cloth) as a function of the instantaneous process step. The variation can be carried out by controlling on the basis of known and stored data for the cloth consumption depending on the process step and/or on the cloth being used.

In accordance with a further mode of the method of the invention, which is advantageous and therefore preferred due to the achievable minimization of the quantity of liquid, the quantity of liquid striking per unit time is varied. In this case, too, an increase in the process quality can be achieved in an advantageous way, since the variable liquid metering can be matched to the running process step, so that a quantity of liquid which is necessary for the processing and is likewise adequate is applied. The variation can be carried out by controlling on the basis of known and stored data for the liquid requirement depending on the process step and/or on the cloth being used. Alternatively, regulation on the basis of sensor data (e.g. measuring the quantity of liquid on the printing technology surface), is possible.

In accordance with an added mode of the method of the invention, which is advantageous and therefore preferred due to the optimization of the process quality which is achievable thereby, a contact pressure of the cloth on the surface is varied. The contact pressure can be varied, for example, as a function of the angular position of the printing technology surface.

In accordance with an additional mode of the method of the invention, which is advantageous and therefore preferred due to the optimization of the process quality which is achievable thereby, the rotational speed of the printing technology surface is varied substantially in stages and is lower in a first stage of the method than in a second stage of the method. The method stages in this case can correspond to the respective angular position of the printing technology surface. The first stage can be chosen, for example, when the leading edge region is located in the active range of the jet nozzles and of the cloth. The second stage can be chosen, for example, when the region of the printing technology surface following the leading edge region (“central region”) is located in this active range.

In accordance with yet another mode of the method of the invention, which is advantageous and therefore preferred due to the optimization of the process quality that is achievable thereby, the feed speed of the cloth is lower in a first stage than in a second stage. As in the aforementioned mode, the stages in this case can also correspond to the position of the printing technology surface relative to the active range.

In accordance with yet a further mode of the method of the invention, which is advantageous and therefore preferred for optimized processing, the first stage (at preferably a relatively lower speed) is chosen when liquid is applied to the printing technology surface.

In accordance with yet an added mode of the method of the invention, which is advantageous and therefore preferred with regard to the optimization of the overall process (e.g. shortening the time), during a treatment of the printing technology surface, a counter is incremented and the rotational speed and/or the feed speed and/or the quantity of liquid and/or the contact pressure is or are varied as a function of the counter reading.

With the objects of the invention in view, there is also provided a machine for processing printing material, for example a printing press, in particular a sheet-processing rotary printing press for lithographic offset printing, in particular suitable for implementing the method of the invention. The machine comprises a printing technology surface, a cloth, and a control device rotating the printing technology surface at a varying rotational speed and moving the cloth at a varying feed speed.

With the objects of the invention in view, there is concomitantly provided a machine for treating printing technology surfaces, for example a printing press, in particular a sheet-processing rotary printing press for lithographic offset printing or, for example, a printing plate processor, in particular a printing plate exposer, in particular suitable for implementing the method of the invention. The machine comprises a printing form for applying a printing image to a printing material, a cloth, and a control device rotating the printing form at a varying rotational speed and moving the cloth at a varying feed speed.

The invention which is described and the advantageous developments of the invention that are also described additionally constitute advantageous developments of the invention in combination with one another. A particularly preferred combination is constituted by the following method: i) high application of liquid (e.g. aqueous solution of amphiphilic molecules) at low rotational speed and with slow or no cloth feed in the region of the leading edge, and ii) low or no application of liquid at high rotational speed in the following region.

Other features which are considered as characteristic for the invention are set forth in the appended claims.

Although the invention is illustrated and described herein as embodied in a method and a machine for treating a reusable printing technology surface with at least one liquid and a machine for processing printing material, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

The invention as such as well as structurally and/or functionally advantageous developments of the invention, will be described in more detail below with reference to the associated drawings and by using at least one preferred exemplary embodiment. In the drawings, mutually corresponding elements are provided with the same reference symbols in each case.

### BRIEF DESCRIPTION OF THE SEVERAL VIEWS OF THE DRAWING

FIG. 1 is a fragmentary, diagrammatic, cross-sectional view of a preferred exemplary embodiment of a machine processing printing material or treating printing technology surfaces;

FIG. 2 is a flowchart of a preferred exemplary embodiment of a method according to the invention for treating a reusable printing technology surface; and

FIG. 3 is a plan view of a printing technology surface treated in accordance with the invention.

### DETAILED DESCRIPTION OF THE INVENTION

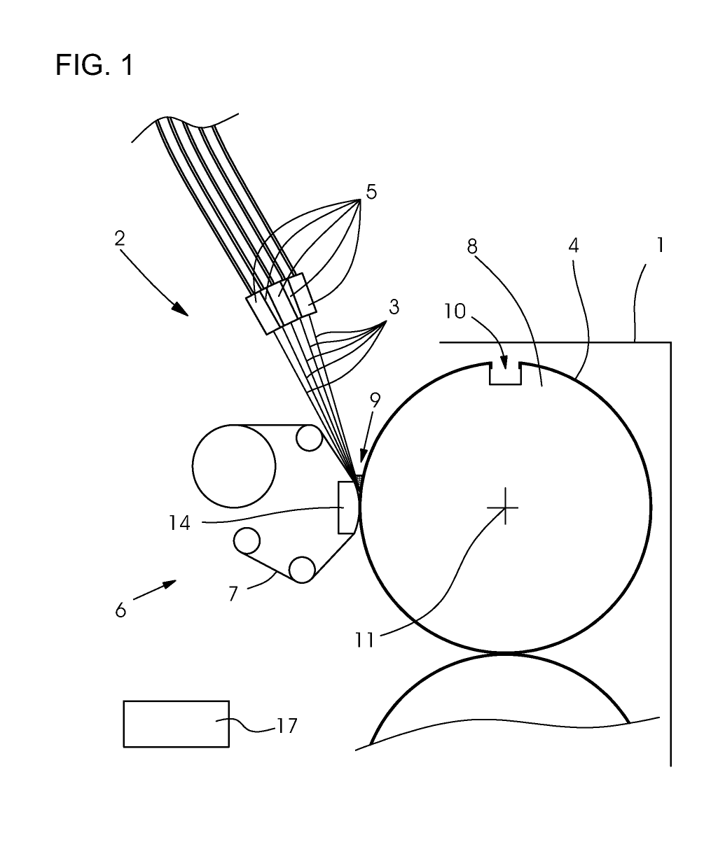

Referring now to the figures of the drawings in detail and first, particularly, to FIG. 1 thereof, there is seen a diagrammatic cross section of a machine 1 for processing printing material or treating printing technology surfaces and having a device 2 for applying one or more liquids 3 as a liquid jet to a rotatable, reusable printing technology surface 4. The device has jet nozzles 5 and a cloth unit 6 with a cloth 7. Such a device for the application of liquids with jet nozzles and treating printing technology surfaces with a cloth according to the method is described, for example, in German Published, Non-Prosecuted Patent Application DE 10 2007 038 141.9, corresponding to copending U.S. application Ser. No. 12/176,737, filed Jul. 21, 2008, which is incorporated by reference herein.

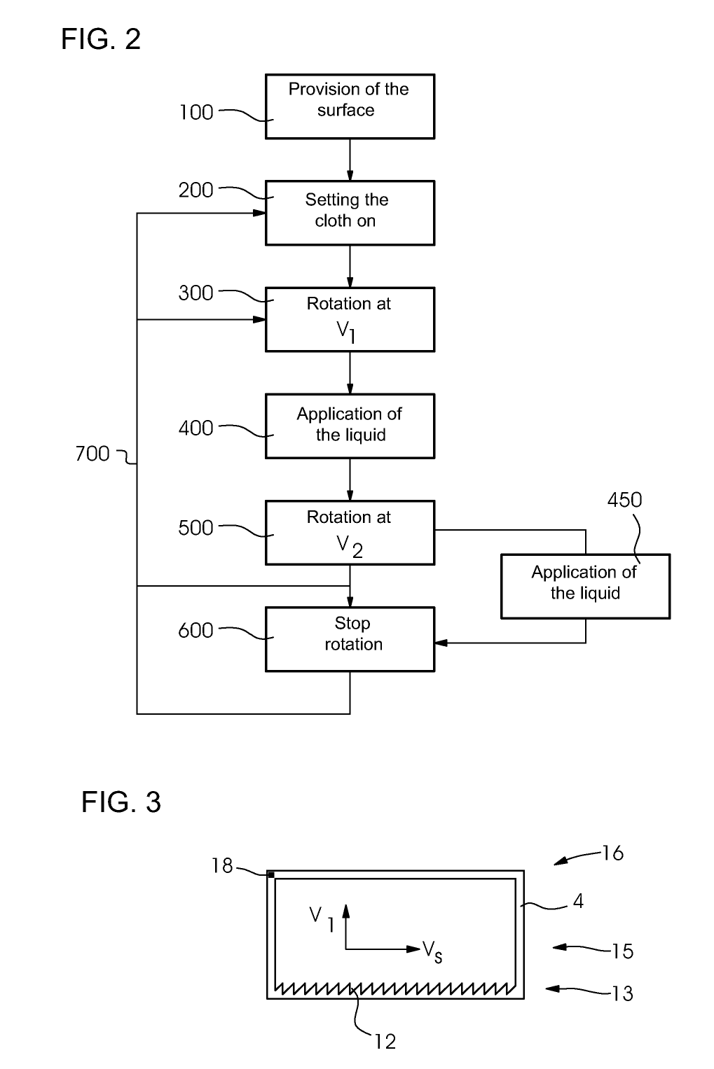

FIG. 2 shows a flowchart of a preferred exemplary embodiment of a method according to the invention for treating a reusable printing technology surface 4, preferably a printing form that can be re-imaged or a surface that can be regenerated and makes contact with a printing material, with at least one liquid 3, in particular a so-called process liquid. The method according to the invention can be performed once or many times. In the event that the method is performed many times, various liquids are preferably applied one after another. Within the context of the method of the invention, a drying method step without application of liquid can also be provided.

The liquid 3 can be water, a cleaning fluid, a rinsing liquid, a solution of amphiphilic molecules, e.g. phosphonic or hydroxamic acid, or a solution of a gumming agent, e.g. carboxymethyl cellulose (CMC). Since the liquids used exhibit different wetting behavior (both on the printing technology surface 4 and in the cloth 7), provision can advantageously be made to adapt the rotational speed of the printing technology surface 4 and the feed speed of the cloth 7 in an appropriate way for an optimal treatment.

In a method step 100 (provision), the printing technology surface 4 is provided on, in particular stretched on, a rotating cylinder 8 having a cylinder axis 11. According to the invention, the printing technology surface 4 can be rotated about the cylinder axis 11 at a varying rotational speed. Alternatively, instead of a printing technology surface (plate or sleeve) stretched on a cylinder 8, the circumferential surface of the cylinder 8 itself can form the printing technology surface 4.

In a method step 200 (setting the cloth on), the movable cloth 7, in particular a section of the cloth 7, is set against the printing technology surface 4 and thus forms a nip or pocket 9 between the cloth surface and the printing technology surface 4. The cloth 7 can be accommodated as a roll of cloth disposed substantially parallel to the axis of rotation in the cloth unit 6. The cloth 7 can be moved in as much as it can at least be spooled forward, preferably also spooled back. The spooling can be carried out continuously or stepwise. The cloth 7 is used to pick up liquid 3, firstly to distribute the latter thinly, homogeneously and reproducibly on the surface 4, secondly in order to remove it from the surface 4. During the method step 200, the cloth 7 can be set on and off in a cyclic manner or, for example, remain set on in continuous wiping operation. If the cylinder 8 has a channel 10, the cloth 7 can be spooled forward or back at high speed in an angular region of the channel 10.

In a method step 300 (rotation at a first rotational speed), the printing technology surface 4 is set rotating, with a first rotational speed V₁ (web speed of the surface) being chosen in this first stage. The first rotational speed V₁ is chosen to be lower than a second rotational speed V₂ in a second stage. The first rotational speed V₁ can even be close to zero, so that a quasi stoppage/inching operation is carried out.

In a method step 400 (application of the liquid), a first liquid 3a is applied to the printing technology surface 4. The first liquid 3a is applied to the surface 4 in the form of a jet and at a varying angle, in particular it is introduced into the nip 9. The first liquid 3a is preferably applied with a number of jet nozzles 5, which are disposed along a straight line substantially parallel to the cylinder axis 11 in such a way that they can be pivoted and in each case can be pivoted about an axis substantially perpendicular to the axis of rotation 11.

The application of the first liquid in method step 400 is carried out through the use of a substantially simultaneous pivoting movement of the jet nozzles 5 with simultaneous rotation of the printing technology surface 4 at the low first rotational speed V₁. As a result of the superimposition of the pivoting movement V_{S} of the jet nozzles 5 with the first rotational speed V₁, so-called covering triangles 12 (see FIG. 3) are formed. In the region of the covering triangles 12, for example at a leading or front edge 13 of the printing technology surface 4, no complete coverage of the printing technology surface 4 with the first liquid 3a is carried out in the lateral direction (parallel to the cylinder axis 11). Covering triangles 12 can be produced during each new metering surge from the jet nozzles except at the plate edge and at the “plate start” (therefore also in the “plate center”).

The first rotational speed V₁ is preferably chosen (to be low) in such a way that, with a given speed of the pivoting movement V_{S} of the jet nozzles 5, the covering triangles 12 are sufficiently small. As is shown in FIG. 3, the covering triangles 12 are preferably kept so small that a visible negative effect on the printing image to be produced on the printing technology surface 4 (in the case of a printing form) or on the printing material with which the printing technology surface 4 is to make contact (in the case of a surface making contact with the printing material) is avoided.

In a method step 500 (rotation at the second rotational speed), the printing technology surface 4 is rotated further with the cloth 7 set on. Preferably, no further application of liquid 3 takes place in method step 500. Instead, the liquid applied in method step 400 is distributed on the surface of the printing technology surface 4 (as an alternative see method step 450). In this second stage of the rotation, a second rotational speed V₂ is chosen. The second rotational speed V₂ is chosen to be higher than the first rotational speed V₁ (V₂>V₁) in a first stage. Preferably, the second rotational speed V₂ is chosen (to be as high as possible) in such a way that the processing of the printing technology surface 4 is carried out in the shortest possible time but visible negative effects on the printing image to be produced or on the printing material with which contact is to be made, are avoided.

In a method step 600 (stop rotation), the rotation is stopped or alternatively a change is made back to the first rotational speed V₁. The rotation preferably includes one or more complete revolutions of the printing technology surface 4 around the cylinder axis 11.

If the method of the invention is considered overall, then the printing technology surface 4 is rotated at a rotational speed V which varies, in particular varies in stages: firstly at the (low) first rotational speed V₁ in the first stage (in order to reduce the effects of the covering triangles) and then at the (high) second rotational speed V₂ in the second stage (in order to reduce the overall time for the processing). The method according to the invention thus uses a two-stage or even multi-stage speed profile of the cylinder rotational speed. The transition between the speed stages is advantageously carried out substantially abruptly. However, provision can also be made for the printing technology surface 4 to rotate at a rotational speed that varies as a function of the angular position of the printing technology surface 4.

The method of the invention also offers the possibility of moving the cloth 7 at a feed speed V_{T} which varies, in particular varies in stages. For instance, provision can be made to move the cloth 7 at a (low) first feed speed V_{T1} in method step 300 and at a (high) second feed speed V_{T2} in method step 500. The low feed speed V_{T1} in the first stage advantageously provides a sufficient distribution of the liquid 3 in the cloth 7, therefore adequate impregnation of the cloth 7 with the liquid 3 and trouble-free treatment (e.g. cleaning, rinsing, covering, gumming) of the printing technology surface 4. However, provision can also be made for the cloth 7 to be moved at a feed speed V_{T} which varies as a function of the angular position of the printing technology surface 4. Furthermore, provision can also be made to move the cloth 7 at a feed speed V_{T} which varies as a function of the respective process step.

The method according to the invention also offers the possibility of varying the quantity of liquid M striking per unit time (M₁, M₂), preferably through the use of a change in the so-called metering surges of the jet nozzles 5 carried out per unit time. For instance, in method step 400, more liquid 3 per unit time can be metered into the nip 9 than in method step 450, so that a sufficient distribution of the liquid 3 in the cloth 7, therefore adequate impregnation of the cloth 7 with the liquid 3 and trouble-free treatment (e.g. cleaning, rinsing, covering, gumming) of the printing technology surface 4, is ensured. However, provision can also be made for the quantity of liquid M striking per unit time, preferably the metering surges carried out per unit time, to be varied as a function of the angular position of the printing technology surface 4.

In order to treat the printing technology surface 4, it may be necessary to apply a number of liquids 3 one after another. To this end, the method of the invention can be operated as a circular process 700, in that a start is made again at method step 200 (if the cloth 7 has been set off) or 300. A second liquid 3b is applied in the second pass instead of the first liquid 3a.

Provision can be made to vary the contact pressure of the cloth 7, for example imparted by a pressure lip 14, in particular as a function of the angular position of the printing technology surface 4. In this way, the wiping effect of the cloth 7 can be increased or reduced.

The above-mentioned functions of the angular position of the printing technology surface 4 can be given, for example, by a dependence on angular sectors: the angular sector of the region of the (printing form) leading edge 13, the angular sector of the region of the printing image or of the contact 15 with the printing material, the angular sector of the region of the (printing form) trailing edge 16. In this way, in the leading edge region 13 covering triangles 12 are reduced, in the central region 15 a reproducible and homogeneous application of liquid is carried out (production of a thin, homogeneous film), and in the trailing edge region 16 a virtually residue-free pick-up of liquid and dirt residues by the cloth 7 is ensured.

The method is preferably implemented through the use of a control device 17, which rotates a printing technology surface 4 at a varying rotational speed and moves a cloth 7 at a varying feed speed. The control device 17 preferably has various programs, which permit rotational speeds and feed speeds matched to the respective liquid 3 to be processed.

Since the printing technology surfaces 4 (both the printing forms and the surfaces making contact with the printing material) are used many times, provision can advantageously be made to vary the method as a function of the number of cycles run, which means, in other words: as a function of the level of aging of the printing technology surface 4. For instance, provision can be made to ensure that, during a treatment (preferably during each treatment) of the printing technology surface 4, a counter is incremented, and that the rotational speed and/or the feed speed and/or the quantity of liquid and/or the contact pressure is or are varied as a function of the counter reading. In order to be able to interrogate the counter reading at any time, for example in a plate exposer, provision can be made to note the counter reading on the printing technology surface 4 (e.g. bar coding) or to store it in a storage medium 18 (e.g. RFID) applied to the printing technology surface. In addition, information about the type of printing technology surface 4, its level of soiling measured or calculated from the ink covering, can also be noted or stored.

The control device 17 also permits the adaptation of further parameters to the surface 4 currently to be treated (as a function of the counter) and/or the liquids 3 currently to be processed:

start and stop times of the cylinder rotation and/or the cloth feed;

metering angle of the jet nozzles;

number of pivoting movements of the jet nozzles per unit time;

type of wiping (e.g. continuous wiping, wiping with/without slippage);

pressing angle of the pressure lip; and

cloth tension.

The following is a concrete example of a method according to the invention for treating a reusable printing technology surface 4, in particular a printing form:
A. coarse cleaning of the printing technology surface 4: 1st -6th cylinder revolution, cleaning fluid I, 3 bar contact pressure of the lip 14, 100 mm/s rotational speed V₁ (V₂=10 mm/s in the region of the leading edge), 1 mm/s cloth speed V_{T1} (continuous wiping);
B. drying of the printing technology surface 4: 7th -8th cylinder revolution, without liquid, 2 bar contact pressure of the lip 14, 200 mm/s rotational speed V₃, 0.5 mm/s cloth speed V_{T2} (continuous wiping);
C. fine cleaning A of the printing technology surface 4: 9th -11th cylinder revolution, cleaning fluid II, 3 bar contact pressure of the lip 14, 100 mm/s rotational speed V₄, cloth spooling in the channel;
D. drying of the printing technology surface 4: 12th -14th cylinder revolution, without liquid, 2 bar contact pressure of the lip 14;
E. fine cleaning B of the printing technology surface 4: 16th -18th cylinder revolution, cleaning fluid III, 1 bar contact pressure of the lip 14, 400 mm/s rotational speed V₅ (V₆=10 mm/s in the region of the leading edge);
F. covering of the printing technology surface 4 with amphiphilic molecules: 19th-22nd cylinder revolution, covering liquid (aqueous solution of amphiphilic molecules), 1 bar contact pressure of the lip 14, 100 mm/s rotational speed V₇ (V₈=10 mm/s in the region of the leading edge), cloth spooling in the channel; and
G. drying of the printing technology surface 4: 23rd-25th cylinder revolution, without liquid, 1 bar contact pressure of the lip 14.

The following is a listing of the possible parameter ranges:
A. cylinder rotational speed V₁-Vₙ: 0-about 500 mm/s (inching: about 5 mm/s between 0 and about 30°);
B. cloth feed speed V_{T1}-V_{Tn}: 0-about 100 mm/s;
   a. continuous wiping V_{T1}-V_{Tn}: 0-about 10 mm/s;
   b. fast spooling V_{T1}-V_{Tn}: about 70-about 100 mm/s;
C. contact pressure of pressure lip of the cloth device: 0-about 4 bar;
D. metering time per metering surge of the jet nozzles 5: about 150-about 500 ms; and
E. metering pressure of the liquids: 0-about 2 bar.

1. A method for treating a reusable printing technology surface with at least one liquid, the method comprising the following steps:
rotating the printing technology surface at a varying rotational speed about a cylinder axis;
applying the liquid to the printing technology surface in the form of a jet and at a varying angle; and
contacting the printing technology surface with a movable cloth.

2. The method according to claim 1, which further comprises moving the cloth at a varying feed speed.

3. The method according to claim 1, which further comprises varying a quantity of the liquid striking per unit time.

4. The method according to claim 1, which further comprises varying a contact pressure of the cloth on the printing technology surface.

5. The method according to claim 1, which further comprises varying the rotational speed of the printing technology surface substantially in stages and rotating the printing technology surface at a lower rotational speed in a first stage of the method than in a second stage of the method.

6. The method according to claim 5, which further comprises feeding the cloth at a lower speed in the first stage than in the second stage.

7. The method according to claim 5, which further comprises choosing the first stage to be when liquid is applied to the printing technology surface.

8. The method according to claim 1, which further comprises, during a treatment of the printing technology surface, incrementing a counter and varying at least one of the rotational speed or the feed speed or the quantity of liquid or the contact pressure as a function of a reading of the counter.

9. A machine for processing printing material, the machine comprising:
a printing technology surface;
a cloth; and
a control device rotating said printing technology surface at a varying rotational speed and moving said cloth at a varying feed speed.

10. The machine according to claim 9, wherein the machine is a printing press.

11. The machine according to claim 9, wherein the machine is a sheet-processing rotary printing press for lithographic offset printing.

12. A machine for treating printing technology surfaces, the machine comprising:
a printing form for applying a printing image to a printing material;
a cloth; and
a control device rotating said printing form at a varying rotational speed and moving said cloth at a varying feed speed.

13. The machine according to claim 12, wherein the machine is a printing press.

14. The machine according to claim 12, wherein the machine is a sheet-processing rotary printing press for lithographic offset printing.

15. The machine according to claim 12, wherein the machine is a printing plate processor.

16. The machine according to claim 12, wherein the machine is a printing plate exposer.
